(19) United States
(12) Patent Application Publication
(10) Pub. No.: US 2024/0265216 A1
(43) Pub. Date: Aug. 8, 2024

(54) SERVER APPARATUS, READING OPERATION ASSISTANCE METHOD, AND NON-TRANSITORY COMPUTER-READABLE MEDIUM

(71) Applicant: NEC Corporation, Minato-ku, Tokyo (JP)

(72) Inventor: Masaaki OOISHI, Tokyo (JP)

(73) Assignee: NEC Corporation, Minato-ku, Tokyo (JP)

(21) Appl. No.: 18/567,148

(22) PCT Filed: Dec. 10, 2021
(86) PCT No.: PCT/JP2021/045573

§ 371 Date: Dec. 5, 2023

(30) Foreign Application Priority Data
Jun. 9, 2021 (JP) 2021-096518
Nov. 29, 2021 (JP) 2021-192841

(51) Int. Cl. G06K 7/10

(52) U.S. Cl. CPC G06K 7/10297

(57) ABSTRACT

A reading system (1) includes a reading device (10) and a server apparatus (20). The reading device (10) includes a transmission unit (110) that transmits own model information to the server apparatus (20), a reception unit (120) that receives, from the server apparatus (20), guide information for displaying a position of a medium (30) relative to the reading device (10) during wireless communication, and a display processing unit (130) that causes a display (12) to display a display element based on the guide information. The server apparatus (20) includes an acquisition unit (210) that acquires model information from the reading device (10), and a guide information transmission unit (220) that acquires associated guide information, based on the model information, and transmits the guide information to the reading device (10).

### TECHNICAL FIELD

The present invention relates to a technique for assisting a user operation when communication is performed between a medium having a wireless communication function and a reading device.

### BACKGROUND ART

Various services using a medium (e.g., a contactless integrated circuit (IC) card, or the like) compatible with a near field communication (NFC) standard are provided. In a service utilizing the NFC technique, reading of information stored in a medium or writing of information into the medium is executed by bringing the medium close to a reading device.

In a service that utilizes the NFC technique, especially for a person who is unfamiliar therewith, it takes time to align a medium and a reading device, and communication may not be able to be successfully executed between the medium and the reading device. One example of a technique that solves such a problem is disclosed in, for example, Patent Document 1. Patent Document 1 discloses a technique in which an information reading apparatus having a function of reading information from an IC card causes a display of the information reading apparatus to display a guide figure indicating a reading position of the IC card, and changes a display position of the guide figure, based on a detection result of a communication state.

### RELATED DOCUMENT

### Patent Document

Patent Document 1: Japanese Patent Application Publication No. 2010-211577

### SUMMARY OF INVENTION

### Technical Problem

In recent years, various devices have been equipped with a near field wireless communication technique such as an NFC module, and the number of devices being utilizable as a reading device of a wireless communication medium has been increasing. Herein, an internal structure (e.g., a position of an antenna) of a device being utilizable as a reading device of a wireless communication medium differs according to a model. Due to such a difference of an internal structure according to a model, an appropriate positional relationship for performing stable wireless communication between a medium and a reading device differs. When providing a service utilizing a wireless communication technique in various reading devices, it is necessary to consider such a difference of a positional relationship.

The present invention has been made in view of the problem described above. One of objects of the present invention is to provide a technique for guiding in such a way that a wireless communication medium and a reading device have an appropriate positional relationship when wireless communication is performed between the wireless communication medium and the reading device.

### Solution to Problem

A server apparatus according to the present disclosure includes:
an acquisition unit that acquires model information of a reading device having a display; and
a guide information transmission unit that acquires, based on the model information, guide information for causing the display to display a position of a wireless communication medium relative to the reading device during wireless communication, and transmits the guide information to the reading device.

A first reading operation assistance method according to the present disclosure includes,
by a computer:
acquiring model information of a reading device having a display;
acquiring, based on the model information, guide information for causing the display to display a position of a wireless communication medium relative to the reading device during wireless communication; and
transmitting the guide information to the reading device.

A first program according to the present disclosure causes
a computer to function as:
an acquisition unit that acquires model information of a reading device having a display; and
a guide information transmission unit that acquires, based on the model information, guide information for causing the display to display a position of a wireless communication medium relative to the reading device during wireless communication, and transmits the guide information to the reading device.

A second program according to the present disclosure
is a program to be installed in a reading device having a display, and causes
the reading device to function as:
   a transmission unit that transmits model information of the reading device to a server apparatus;
   a reception unit that receives guide information for causing the display to display a position of a wireless communication medium relative to the reading device during wireless communication, the guide information being determined based on the model information by the server apparatus; and
   a display processing unit that causes the display of the reading device to display, based on the guide information, a display element indicating a position of the wireless communication medium relative to the reading device during wireless communication.

A second reading operation assistance method according to the present disclosure includes,
by a reading device having a display:
transmitting model information of the reading device to a server apparatus;
receiving guide information for causing the display to display a position of a wireless communication medium relative to the reading device during wireless communication, the guide information being determined based on the model information by the server apparatus; and
causing the display of the reading device to display, based on the guide information, a display element indicating a position of the wireless communication medium relative to the reading device during wireless communication.

A reading device according to the present disclosure
is a reading device having a display and includes:
a transmission unit that transmits model information of the reading device to a server apparatus;
a reception unit that receives guide information for causing the display to display a position of a wireless communication medium relative to the reading device during wireless communication, the guide information being determined based on the model information by the server apparatus; and
a display processing unit that causes the display of the reading device to display, based on the guide information, a display element indicating a position of the wireless communication medium relative to the reading device during wireless communication.

### Advantageous Effects of Invention

The present invention allows, when wireless communication is performed between a wireless communication medium and a reading device, an appropriate positional relationship between the wireless communication medium and the reading device to be easily recognized.

### BRIEF DESCRIPTION OF DRAWINGS

FIG. 1 It is a diagram conceptually illustrating a configuration of a reading system according to the present disclosure.

FIG. 2 It is a diagram schematically representing a positional relationship between a reading device and a wireless communication medium when wireless communication is performed between the reading device and the wireless communication medium.

FIG. 3 It is a block diagram illustrating a hardware configuration of the reading device.

FIG. 4 It is a block diagram illustrating a hardware configuration of a server apparatus.

FIG. 5 It is a sequence diagram illustrating a flow of processing executed by a reading device and a server apparatus according to a first example embodiment.

FIG. 6 It is a diagram illustrating one example of information stored in a guide information database according to the first example embodiment.

FIG. 7 It is a diagram illustrating one example of a display element based on guide information.

FIG. 8 It is a diagram illustrating another example of a display element based on guide information.

FIG. 9 It is a diagram illustrating a scene in which a positional relationship between a reading device and a wireless communication medium is adjusted according to a display element based on the guide information illustrated in FIG. 7.

FIG. 10 It is a diagram illustrating one example of information indicating a time until communication completion.

FIG. 11 It is a sequence diagram illustrating a flow of processing executed by a reading device and a server apparatus according to a second example embodiment.

FIG. 12 It is a diagram illustrating one example of information stored in guide information database according to the second example embodiment.

FIG. 13 It is a diagram illustrating one example of a display element based on guide information outputable in the second example embodiment.

FIG. 14 It is a diagram illustrating another example of a display element based on guide information outputable in the second example embodiment.

FIG. 15 It is a diagram illustrating a scene in which a positional relationship between a reading device and a wireless communication medium is adjusted according to a display element based on the guide information illustrated in FIG. 13.

FIG. 16 It is a diagram illustrating one example of a display element based on guide information output by a display processing unit according to a third example embodiment.

FIG. 17 It is a diagram illustrating another example of a display element based on guide information output by a display processing unit according to the third example embodiment.

### DESCRIPTION OF EMBODIMENTS

Hereinafter, example embodiments according to the present invention are described by use of the drawings. Note that, in all of the drawings, a similar component is assigned with a similar reference sign, and description thereof will not be repeated as appropriate. Moreover, unless otherwise specially described, each block represents, in each block diagram, not a configuration on a hardware basis but a configuration on a function basis. Moreover, when there is an arrow in a figure, a direction of the arrow only serves to ease understanding of a flow of information, and does not limit a direction of communication (one-way communication/two-way communication) unless otherwise specially described.

### First Example Embodiment

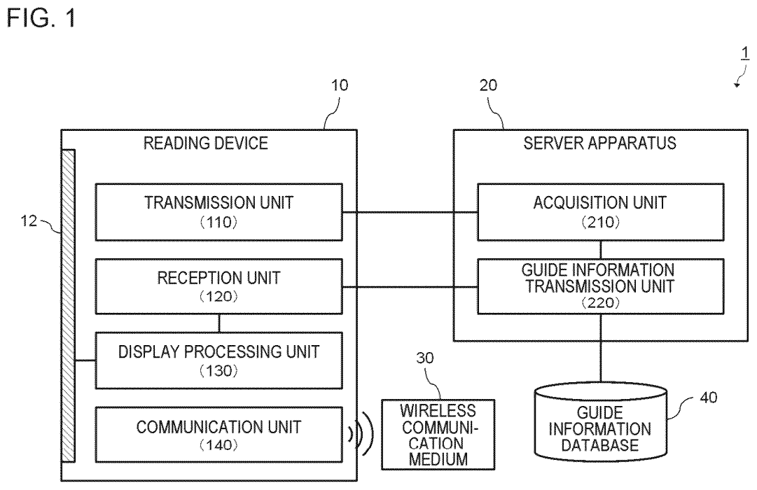

FIG. 1 is a diagram conceptually illustrating a configuration of a reading system according to the present disclosure. A reading system 1 illustrated in FIG. 1 is configured by including a reading device 10 and a server apparatus 20.

### <Configuration of Reading Device 10>

The reading device 10 is a device that performs wireless communication with a medium 30 (hereinafter, also referred to as a “wireless communication medium”) having a wireless communication function. Although not particularly limited, the reading device 10 is, for example, a portable terminal such as a smartphone or a tablet terminal. The reading device 10 has at least a function of reading information stored in the wireless communication medium 30 from the wireless communication medium 30. Note that, the reading device 10 may further have a function of writing any information in a storage area of the wireless communication medium 30. The reading device 10 illustrated in FIG. 1 includes a display 12, a transmission unit 110, a reception unit 120, a display processing unit 130, and a communication unit 140.

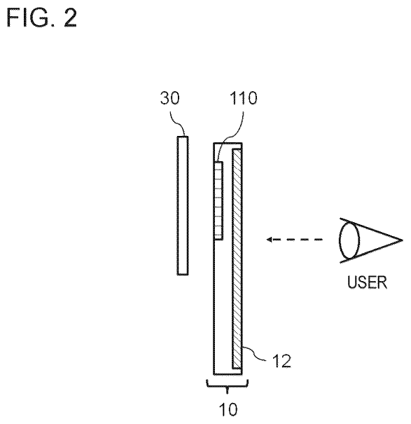

The communication unit 140 can perform contactless wireless communication with the wireless communication medium 30. The communication unit 140 is compatible with various contactless wireless communication standards such as ISO/IEC 10536, ISO/IEC 14443 (Type-A, Type-B), and ISO/IEC 18092, and performs wireless communication with the wireless communication medium 30. The communication unit 140 is achieved by a structure similar to a structure adopted in a known reading device. In the reading system 1 according to the present disclosure, the communication unit 140 (a position where the reading device 10 performs communication with the wireless communication medium 30) is provided on a second surface located on a side opposite to a first surface on which the display 12 is provided. Thus, when wireless communication is performed between the reading device 10 and the wireless communication medium 30, a basic positional relationship between the reading device 10 and the wireless communication medium 30 is in such a state as illustrated in FIG. 2. FIG. 2 is a diagram schematically representing a positional relationship between the reading device 10 and the wireless communication medium 30 when wireless communication is performed between the reading device 10 and the wireless communication medium 30. As illustrated in FIG. 2, when the reading device 10 and the wireless communication medium 30 are brought close to each other in order to perform wireless communication, the wireless communication medium 30 is located on a side behind the reading device 10 (display 12) as seen from a user.

The transmission unit 110, the reception unit 120, and the display processing unit 130 execute processing for allowing the user to easily recognize an appropriate positional relationship before wireless communication is performed between the communication unit 140 and the wireless communication medium 30 described above.

First, the transmission unit 110 acquires model information of the reading device 10, and transmits the model information to the external server apparatus 20 connected via a non-illustrated network. Note that, the model information is any information being capable of determining an internal structure of a reading device. Although not particularly limited, for example, information indicating a model of a reading device, such as a model name and a model number, is used as model information. Such model information is previously stored in, for example, a predetermined storage area such as a memory of the reading device 10 or a storage device. Herein, when a position of the communication unit 140 is different depending on a model of the reading device 10, a position suitable for wireless communication with the wireless communication medium 30 also differs depending on the difference in a position of the communication unit 140. Model information acquired by the transmission unit 110 is utilized in the server apparatus 20 in order to determine a position where communication can be stably performed between the reading device 10 and the wireless communication medium 30.

The reception unit 120 receives guide information determined by the server apparatus 20, based on the model information transmitted from the transmission unit 110. Herein, the guide information is information for causing the display 12 to display a position of the wireless communication medium 30 relative to the reading device 10 when wireless communication is performed between the reading device 10 and the wireless communication medium 30. A specific example of the guide information is described later.

The display processing unit 130 causes the display 12 to display a display element based on the guide information received by the reception unit 120. Herein, as illustrated in FIG. 2, when the wireless communication medium 30 and the reading device 10 are brought close to each other in order to perform wireless communication, the reading device 10 (display 12) is located between the wireless communication medium 30 and the user. Thereby, at least a part of the wireless communication medium 30 becomes invisible to the user. However, in the present example embodiment, a display element indicating a position of the wireless communication medium 30 relative to the reading device 10 during wireless communication is displayed on the display 12 by guide information determined based on model information. Thus, by simply adjusting a positional relationship between the reading device 10 and the wireless communication medium 30 according to a display element displayed on the display 12, the user can place the reading device 10 and the wireless communication medium 30 at appropriate positions in order to perform wireless communication. By bringing the reading device 10 and the wireless communication medium 30 into an appropriate positional relationship, stable wireless communication becomes possible between the reading device 10 and the wireless communication medium 30.

Each functional component of the reading device 10 may be achieved by hardware (example: a hardwired electronic circuit or the like) that achieves each functional component, or may be achieved by a combination of hardware and software (example: a combination of an electronic circuit and a program that controls the electronic circuit, or the like). A case where each functional component of the reading device 10 is achieved by a combination of hardware and software is further described below.

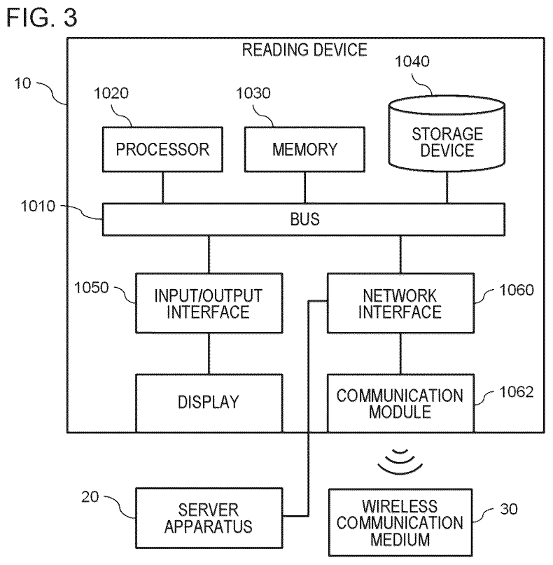

FIG. 3 is a block diagram illustrating a hardware configuration of the reading device 10. In the example of FIG. 3, the reading device 10 includes a bus 1010, a processor 1020, a memory 1030, a storage device 1040, an input/output interface 1050, and a network interface 1060.

The bus 1010 is a data transmission path through which hardware components transmit and receive data to and from each other. However, a method of connecting each hardware component of the reading device 10 is not limited to bus connection.

The processor 1020 is a processor achieved by a central processing unit (CPU), a graphics processing unit (GPU), or the like.

The memory 1030 is a main storage apparatus achieved by a random access memory (RAM) or the like.

The storage device 1040 is an auxiliary storage apparatus achieved by a hard disk drive (HDD), a solid state drive (SSD), a memory card, a read only memory (ROM), or the like. The storage device 1040 stores a program module that achieves each function (the transmission unit 110, the reception unit 120, the display processing unit 130, the communication unit 140, and the like) of the reading device 10. The processor 1020 reads each of the program modules onto the memory 1030, executes the read program module, and thereby achieves each function being associated with the program module on the reading device 10.

The input/output interface 1050 is an interface for connecting the reading device 10 to various kinds of input/output equipment. In the example of FIG. 3, the display 12 is connected to the input/output interface 1050. The display 12 is a liquid crystal display (LCD), an organic electro luminescence (OEL) display, or the like. Note that, the display 12 connected to the input/output interface 1050 may be a touch panel display equipped with a touch panel. Moreover, another input/output apparatus other than the display 12 may be connected to the input/output interface 1050.

The network interface 1060 is an interface for connecting the reading device 10 to a network. The network interface 1060 connects the reading device 10 to a network wiredly or wirelessly. The network is, for example, a local area network (LAN), a wide area network (WAN), or the like. The reading device 10 can transmit and receive various pieces of data by communicating with another apparatus on the network via the network interface 1060. For example, the reading device 10 can transmit model information to the server apparatus 20 and receive guide information from the server apparatus 20 via the network interface 1060. Moreover, as illustrated, a wireless communication module 1062 is connected to the network interface 1060. A wireless communication module 112 is compatible with various NFC standards, and exchanges data between the reading device 10 and the wireless communication medium 30 via a non-illustrated antenna.

Note that, the hardware configuration of the reading device 10 illustrated in FIG. 3 is merely one example. The hardware configuration of the reading device 10 in the present disclosure is not limited to the example illustrated in FIG. 3.

### <Configuration of Server Apparatus 20>

The server apparatus 20 has a function of providing guide information to the reading device 10. The server apparatus 20 illustrated in FIG. 1 includes an acquisition unit 210 and a guide information transmission unit 220.

The acquisition unit 210 acquires model information transmitted from the reading device 10 as described above. The guide information transmission unit 220 acquires guide information, based on the model information acquired by the acquisition unit 210. In the example of FIG. 1, the guide information transmission unit 220 refers to a guide information database 40 storing guide information for each model, and acquires, from the guide information database 40, guide information being associated with the model information acquired from the reading device 10. The guide information database 40 may be provided in the server apparatus 20, or may be provided in another external apparatus communicably connected to the server apparatus 20. As described above, guide information indicates a position of the wireless communication medium 30 relative to the reading device 10 during wireless communication. Then, the guide information transmission unit 220 transmits, to the reading device 10, the guide information acquired based on the model information from the reading device 10.

Each functional component of the server apparatus 20 may be achieved by hardware (example: a hardwired electronic circuit or the like) that achieves each functional component, or may be achieved by a combination of hardware and software (example: a combination of an electronic circuit and a program that controls the electronic circuit, or the like). A case where each functional component of the server apparatus 20 is achieved by a combination of hardware and software is further described below.

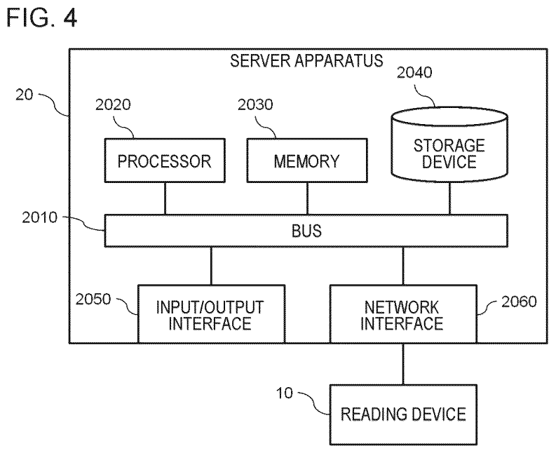

FIG. 4 is a block diagram illustrating a hardware configuration of the server apparatus 20. In the example of FIG. 4, the server apparatus 20 includes a bus 2010, a processor 2020, a memory 2030, a storage device 2040, an input/output interface 2050, and a network interface 2060.

The bus 2010 is a data transmission path through which hardware components transmit and receive data to and from each other. However, a method of connecting each hardware component of the server apparatus 20 is not limited to bus connection.

The processor 2020 is a processor achieved by a central processing unit (CPU), a graphics processing unit (GPU), or the like.

The memory 2030 is a main storage apparatus achieved by a random access memory (RAM) or the like.

The storage device 2040 is an auxiliary storage apparatus achieved by a hard disk drive (HDD), a solid state drive (SSD), a memory card, a read only memory (ROM), or the like. The storage device 2040 stores a program module that achieves each function (the acquisition unit 210, the guide information transmission unit 220, and the like) of the server apparatus 20. The processor 2020 reads each of the program modules onto the memory 2030, executes the read program module, and thereby achieves each function being associated with the program module on the server apparatus 20.

The input/output interface 2050 is an interface for connecting the server apparatus 20 and various kinds of input/output equipment. Various input/output apparatuses such as a keyboard, a mouse, a display, and a speaker are connectable to the input/output interface 2050.

The network interface 2060 is an interface for connecting the server apparatus 20 to a network. The network interface 2060 connects the server apparatus 20 to a network wiredly or wirelessly. The network is, for example, a local area network (LAN), a wide area network (WAN), or the like. The server apparatus 20 can transmit and receive various pieces of data by communicating with another apparatus on the network via the network interface 2060. For example, the server apparatus 20 can acquire model information from the reading device 10, and transmit guide information determined based on the model information to the reading device 10, via the network interface 2060. In addition, when the guide information database 40 described above is provided in an external apparatus (not illustrated) on a network, the server apparatus 20 can access the guide information database 40 of the external apparatus via the network interface 2060, and acquire the guide information being associated with model information acquired from the reading device 10.

Note that, the hardware configuration of the server apparatus 20 illustrated in FIG. 4 is merely one example. The hardware configuration of the server apparatus 20 in the present disclosure is not limited to the example illustrated in FIG. 4.

### <Flow of Processing>

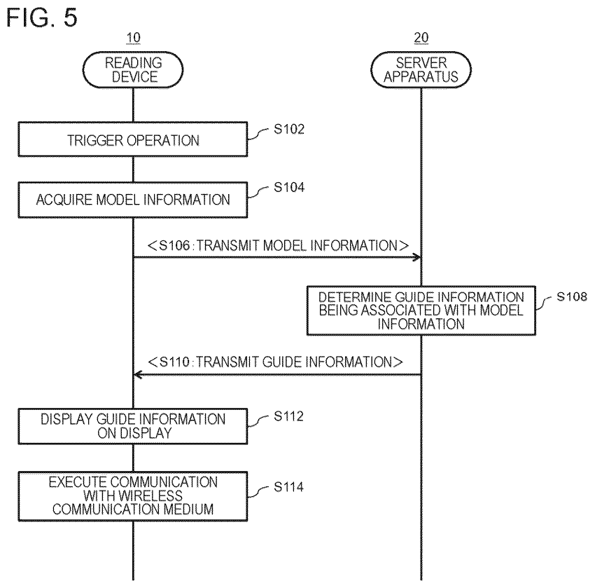

Processing executed by the reading device 10 and the server apparatus 20 is described by use of FIG. 5. FIG. 5 is a sequence diagram illustrating a flow of processing executed by the reading device 10 and server apparatus 20 according to the first example embodiment.

First, on the reading device 10 side, a trigger operation for starting wireless communication with the wireless communication medium 30 is executed (S102). For example, on the display 12 of the reading device 10, an operation in which the user presses a button serving as a trigger for starting wireless communication is executed. In response to the operation, the transmission unit 110 acquires, for example, model information of the reading device 10 stored in, for example, a predetermined storage area of the memory 1030, the storage device 1040, or the like (S104). Then, the transmission unit 110 transmits, to the server apparatus 20, the model information of the reading device 10 acquired in the processing of S104 (S106).

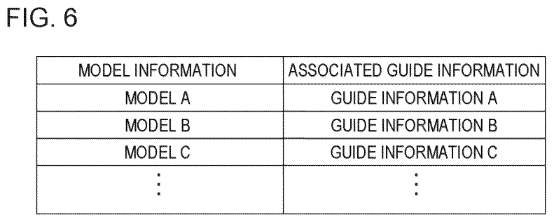

The server apparatus 20 receives, in the acquisition unit 210, the model information transmitted from the reading device 10 in the processing of S106. When the model information of the reading device 10 is acquired by the acquisition unit 210, the guide information transmission unit 220 determines guide information, based on the model information (S108). For example, the guide information transmission unit 220 refers to the guide information database 40 (example: FIG. 6), and acquires, from the guide information database 40, guide information being associated with the model information acquired from the reading device 10. FIG. 6 is a diagram illustrating one example of information stored in the guide information database 40 according to the first example embodiment. In the example of FIG. 6, the guide information database 40 stores guide information according to classification by model information. For example, when the model information transmitted in the processing of S106 indicates a “model A”, the guide information transmission unit 220 can determine, as guide information that should be transmitted to the apparatus 10, “guide information A” being associated with the “model A” in the guide information database 40. Then, the guide information transmission unit 220 transmits the guide information acquired in S108 to the reading device 10 (S110).

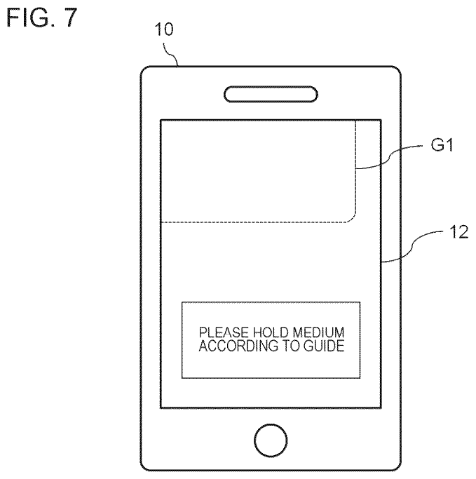

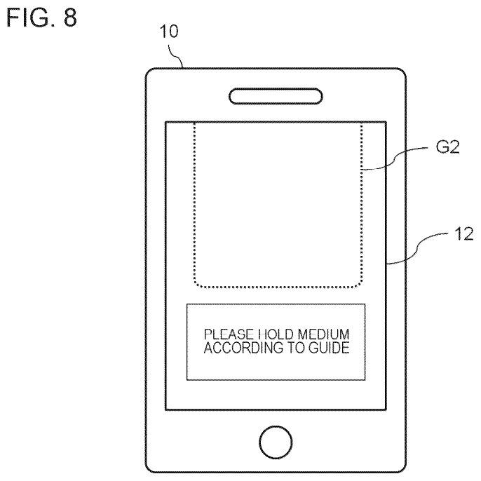

The reception unit 120 acquires the guide information determined by the server apparatus 20, based on the model information transmitted in the processing of S106. When the reception unit 120 acquires the guide information, the display processing unit 130 displays, on the display 12, a display element based on the guide information (S112). For example, the display processing unit 130 displays, on the display 12, such a display element as illustrated in FIG. 7. FIG. 7 is a diagram illustrating one example of a display element based on guide information. A display element G1 based on the guide information illustrated in FIG. 7 indicates a position of at least a part of an edge of the wireless communication medium 30 when the wireless communication medium 30 is placed at a communication position of the reading device 10. Note that, guide information is determined according to model information in the server apparatus 20, and therefore changeable according to a model of the reading device 10. For example, regarding the reading device 10 of a model being different from the reading device 10 in FIG. 7, there is a possibility that a display element based on such guide information as illustrated in FIG. 8 is displayed on the display 12. FIG. 8 is a diagram illustrating another example of a display element based on guide information. In the example of FIG. 8, a display element G2, based on guide information, in which placement of the edge of the wireless communication medium 30 is different from the display element G1 based on the guide information in FIG. 7, is displayed on the display 12. Such a difference of placement of the wireless communication medium 30 relative to the reading device 10 is caused by a difference in an internal structure of the reading device 10.

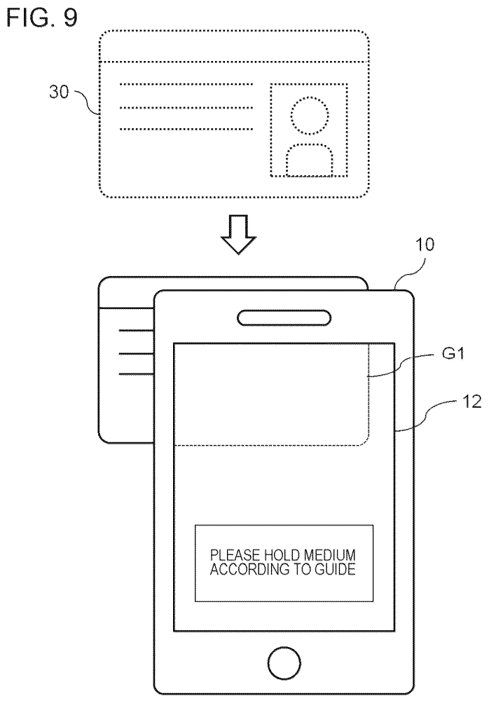

Then, the user adjusts a positional relationship between the reading device 10 and the wireless communication medium 30, according to the guide information displayed on the display 12. For example, when the display element G1 based on the guide information illustrated in FIG. 7 is displayed on the display 12, the user adjusts the positional relationship between the reading device 10 and the wireless communication medium 30 as illustrated in FIG. 9. FIG. 9 is a diagram illustrating a scene in which a positional relationship between the reading device 10 and the wireless communication medium 30 is adjusted according to the display element G1 based on the guide information illustrated in FIG. 7. As illustrated, wireless communication is executed between the reading device 10 and the wireless communication medium 30 by placing the wireless communication medium 30 at a communication position of the reading device 10 according to the display element G1 based on the guide information (S114).

In the present example embodiment, guide information is determined according to a model of the reading device 10 that performs communication with the wireless communication medium 30, and a display element indicating an appropriate positional relationship between the reading device 10 and the wireless communication medium 30 is displayed on the display 12, based on the guide information. The user can easily adjust a positional relationship between the reading device 10 and the wireless communication medium 30 due to a display element based on the guide information, in such a way that stable wireless communication is executed between the reading device 10 and the wireless communication medium 30.

### Modified Example

In the present modified example, the display processing unit 130 is configured in such a way as to further display, on the display 12, information indicating a remaining time until communication completion, for example, while the medium 30 is placed at a communication position of the reading device 10.

Herein, a time required until communication with the wireless communication medium 30 is completed is variable according to model-specific information such as a specification of the reading device 10. The specification of the reading device 10 can be determined by using, for example, model information. In the modified example, the display processing unit 130 determines, by use of model information of the reading device 10, a communication time according to the model information. Note that, the communication time according to the model of the reading device 10 can be determined, for example, based on a result of actually executing reading and writing by using various wireless communication media 30. Moreover, a theoretical value based on a specification of the reading device 10 may be used for a communication time according to a model of the reading device 10. A communication time being associated with a model of the reading device 10 acquired in this way is converted into a database in association with, for example, model information of the reading device 10. In this case, the display processing unit 130 can acquire, from the database, a communication time being associated with model information of the reading device 10.

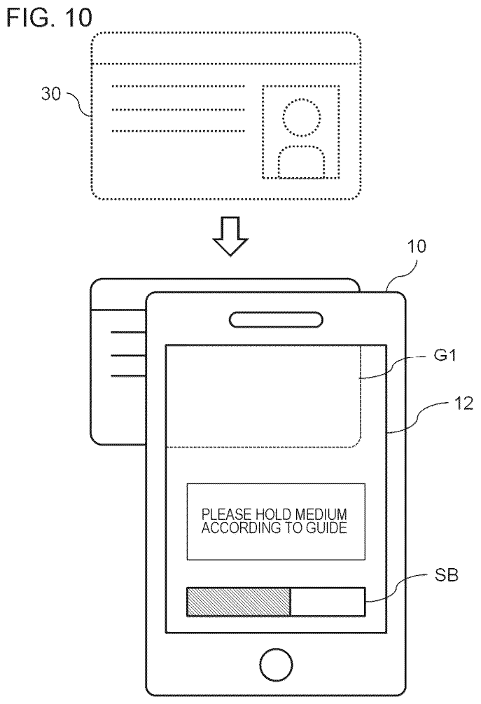

The display processing unit 130 can visualize a time until communication completion according to model information of the reading device 10, for example, as illustrated in FIG. 10, and present the time to a user. FIG. 10 is a diagram illustrating one example of information indicating a time until communication completion. In the example of FIG. 10, the display processing unit 130 further displays, on the display 12, a status bar SB indicating current progress relative to a time until communication completion according to model information. Note that, in the example of FIG. 10, the display processing unit 130 can activate a timer, with, for example, start of wireless communication with the medium 30 in the communication unit 140 as a trigger, and update display on the status bar SB by an elapsed time of the timer. For example, the display processing unit 130 can update display on the status bar SB (display of a shaded region indicating progress), based on a ratio of an elapsed time of the timer to a time until communication completion.

In the configuration according to the modified example, information indicating a remaining time until wireless communication between the reading device 10 and the wireless communication medium 30 is completed is further displayed on the display 12. Such information enables the user to easily recognize wireless communication being performed without any problem between the reading device 10 and the wireless communication medium 30, and progress of the wireless communication.

### Second Example Embodiment

The present example embodiment is similar to the first example embodiment except for points described below. For example, a reading system 1 according to the present example embodiment has a functional configuration (example: FIG. 1) similar to that of the reading system 1 according to the first example embodiment except for points described below.

### <Configuration of Reading Device 10>

In the present example embodiment, a transmission unit 110 acquires medium type information in addition to the model information described in the first example embodiment. The medium type information is information indicating a type of a medium. Then, the transmission unit 110 transmits the model information and the medium type information to a server apparatus 20.

Herein, an internal structure (example: a position of an antenna) of a wireless communication medium 30 may differ depending on a type of the wireless communication medium 30. For example, a position of an antenna may differ between a transportation IC card (one type of the wireless communication medium 30) issued by a certain transportation facility and an electronic money card (another type of the wireless communication medium 30) issued by a certain retail company. When a type of a medium is known from medium type information, an internal structure specific to each type of the wireless communication medium 30, such as a position of an antenna in the wireless communication medium 30 of the type, can be identified. Then, based on an internal structure (example: a position of an antenna) of the wireless communication medium 30 identifiable by medium type information and an internal structure (example: a position of an antenna) of a reading device 10 identifiable by model information of the reading device 10, a position where communication can be stably performed between the reading device 10 and the wireless communication medium 30 can be determined more accurately. In the present example embodiment, based on this concept, guide information is prepared which is associated for each combination of model information and medium type information.

A reception unit 120 receives guide information from the server apparatus 20 similarly to the first example embodiment. Note that, in the present example embodiment, guide information is determined in the server apparatus 20, based on a combination of model information and medium type information.

Then, the display processing unit 130 displays, on a display 12, a display element based on the guide information acquired from the server apparatus 20 as response information to a combination of the model information and the medium type information.

### <Configuration of Server Apparatus 20>

An acquisition unit 210 according to the present example embodiment acquires model information and medium type information from the reading device 10 as described above. A guide information transmission unit 220 acquires, based on a combination of model information and medium type information acquired by the acquisition unit 210, associated guide information from a guide information database 40. Then, the guide information transmission unit 220 transmits, to the reading device 10, the guide information based on the combination of the model information and the medium type information.

### <Flow of Processing>

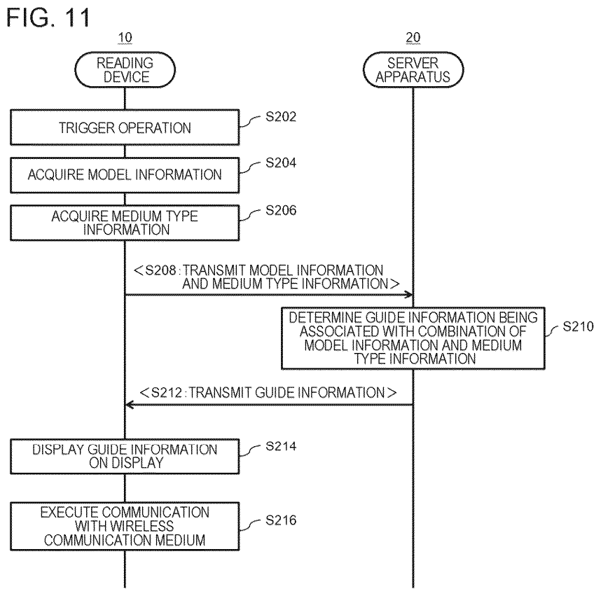

Processing executed by the reading device 10 and the server apparatus 20 is described by use of FIG. 11. FIG. 11 is a sequence diagram illustrating a flow of processing executed by the reading device 10 and the server apparatus 20 according to the second example embodiment.

First, on the reading device 10 side, a trigger operation for starting wireless communication with the medium 30 is executed (S202). For example, an operation in which a user presses, on the display 12 of the reading device 10, a button serving as a trigger for starting wireless communication. In response to the operations, the transmission unit 110 acquires model information of the reading device 10 stored in, for example, a predetermined storage area of a memory 1030, a storage device 1040, or the like (S204). In this instance, the transmission unit 110 further acquires medium type information indicating a type of the wireless communication medium 30. For example, the reading device 10 displays a list of types of usable wireless communication media 30 on the display 12, and accepts a selection input operation performed on the list. The transmission unit 110 acquires, as medium type information, information indicating a type of the wireless communication medium 30 specified by the operation. Moreover, when a type of the wireless communication medium 30 utilized in a service is previously determined, medium type information indicating the type may be previously stored in a storage area of the reading device 10. In this case, the transmission unit 110 can acquire model information and medium type information from a predetermined storage area in response to a trigger operation. Then, the transmission unit 110 transmits, to the server apparatus 20, the model information of the reading device 10 acquired in the processing of S204 and the medium type information acquired in the processing of S206 (S208).

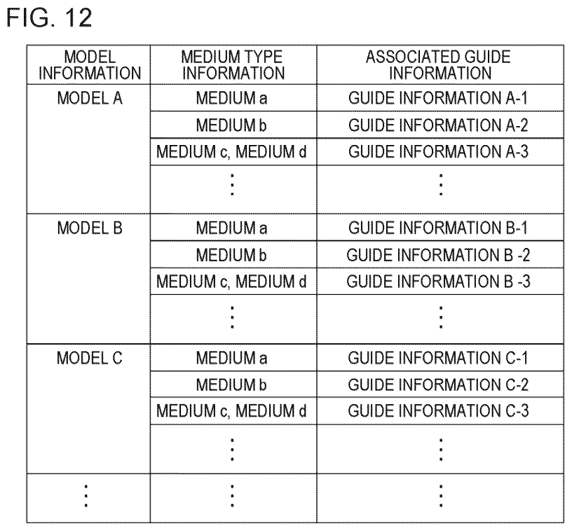

The server apparatus 20 receives, in the acquisition unit 210, the model information and the medium type information of the wireless communication medium 30 transmitted from the reading device 10 in the processing of S208. When the acquisition unit 210 acquires the model information of the reading device 10 and the medium type information of the wireless communication medium 30, the guide information transmission unit 220 determines guide information based on the model information and the medium type information (S210). For example, the guide information transmission unit 220 refers to the guide information database 40 (example: FIG. 12), and acquires, from the guide information database 40, guide information being associated with the model information acquired from the reading device 10. FIG. 12 is a diagram illustrating one example of information stored in the guide information database 40 according to the second example embodiment. In the example of FIG. 12, the guide information database 40 stores guide information according to classification by a combination of model information and medium type information. Note that, even when a type of the wireless communication medium 30 is different, an internal structure (example: a position of an antenna) may be substantially the same. In such a case, even when a combination of model information and medium type information is different, associated guide information may be the same. In the example of FIG. 12, a “medium c” and a “medium d” apply to this case. For example, when the model information and the medium type information transmitted in the processing of S208 indicate a “model A” and the “medium c” (or the “medium d)”, respectively, the guide information transmission unit 220 can determine, as guide information that should be transmitted to the reading device 10, “guide information A-3” being associated with a combination of the “model A” and the “medium c (or the medium d)” in the guide information database 40. Then, the guide information transmission unit 220 transmits, to the reading device 10, the guide information acquired in S210 in this way (S212).

The reception unit 120 acquires guide information determined by the server apparatus 20, based on the combination of the model information and the medium type information transmitted in the processing of S208. When the guide information is acquired by the reception unit 120, the display processing unit 130 displays, on the display 12, a display element based on the guide information (S214).

As one example, the display processing unit 130 displays, on the display 12, a display element indicating a position of at least a part of an edge of the wireless communication medium 30, as illustrated in FIGS. 7 and 8. In the present example embodiment, the display elements illustrated in FIGS. 7 and 8 are determined based on a combination of model information and medium type information.

In the present example embodiment, unlike the first example embodiment, medium type information is further acquired. By making use of the medium type information, an appropriate position of a wireless communication medium relative to the reading device 10 during wireless communication can be indicated to the user.

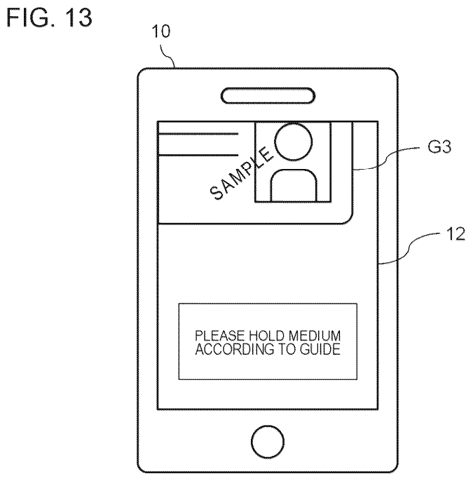

For example, a display element based on guide information may indicate an appearance of a region of the wireless communication medium 30 overlapping the display 12 when the wireless communication medium 30 is placed at the communication position of the reading device 10. The display element in this case is, for example, such information as illustrated in FIG. 13. FIG. 13 is a diagram illustrating one example of a display element based on guide information outputable in the second example embodiment. In the example of FIG. 13, the display 12 displays a display element G3 based on the guide information. A display element G3 based on guide information indicates an appearance of a region (i.e., a region of the wireless communication medium 30 hidden by the display 12) of the wireless communication medium 30 overlapping the display 12. The guide information database 40 stores such guide information as illustrated in FIG. 13 for each combination of model information and medium type information. For example, the guide information database 40 may store, as guide information, a partial image trimmed off the entire image of the wireless communication medium 30 according to a screen size of each model, and display position information of the partial image on the display 12. In this case, the display processing unit 130 can display such guide information as illustrated in FIG. 13, by outputting the partial image acquired from the server apparatus 20 to a position on the display 12 indicated by the display position information also acquired from the server apparatus 20. Moreover, the guide information database 40 may store the entire image of the wireless communication medium 30 instead of a partial image. In this case, the display processing unit 130 may be configured to perform trimming on the entire image of the wireless communication medium 30 acquired from the server apparatus 20 so as to generate a partial image. Moreover, the display processing unit 130 may adjust, without performing trimming, a display position of the entire image of the wireless communication medium 30, based on display position information acquired from the server apparatus 20, and thereby display, on the display 12, only a region in which the display 12 and the wireless communication medium 30 overlap.

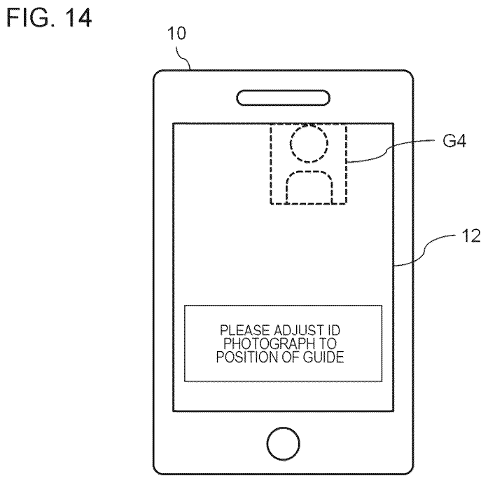

As another example, a display element based on guide information may indicate a position of criterion information of the medium 30 when the medium 30 is placed at a communication position of the reading device 10. The criterion information is information serving as a mark existing on a surface of the medium 30. The criterion information is appropriately determinable from among those included in a region of the medium 30 overlapping the display 12, when the medium 30 is placed at a communication position of the reading device 10. Although not particularly limited, criterion information is preferably a characteristic design existing on a surface of the medium 30, such as an ID photograph, a predetermined character string, or a logo, from a viewpoint of usability. As a specific example, such guide information as illustrated in FIG. 14 is displayed on the display 12. FIG. 14 is a diagram illustrating another example of a display element based on guide information outputable in the second example embodiment. The example of FIG. 14 describes a scene in which, with an ID photograph existing on a surface of the wireless communication medium 30 as criterion information, a display element G4 based on guide information indicating a position thereof is displayed on the display 12.

Note that, a display element based on guide information displayed on the display 12 may be a combination of the specific example described above. For example, a display element based on guide information may indicate a position of at least a part of an edge of the wireless communication medium 30 when the wireless communication medium 30 is placed at a communication position of the reading device 10, and an appearance of a region of the wireless communication medium 30 overlapping the display 12 when the wireless communication medium 30 is placed at the communication position of the reading device 10. Moreover, for example, a display element based on guide information may indicate a position of at least a part of an edge of the wireless communication medium 30 when the wireless communication medium 30 is placed at a communication position of the reading device 10, and a position of criterion information of the wireless communication medium 30 when the wireless communication medium 30 is placed at the communication position of the reading device 10. Moreover, a display element based on guide information is not limited to the illustrated example, and any information can be utilized as long as the information indicates an appropriate positional relationship between the reading device 10 and the wireless communication medium 30.

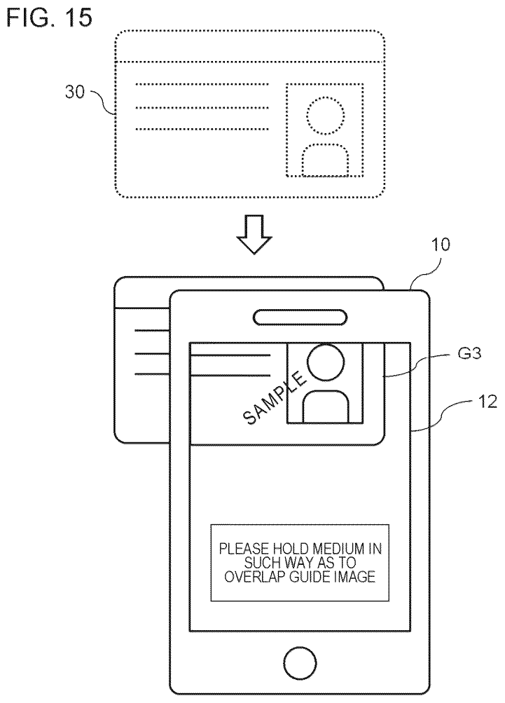

Then, the user adjusts a positional relationship between the reading device 10 and the wireless communication medium 30 according to a display element based on guide information displayed on the display 12. For example, when the display element G3 based on the guide information illustrated in FIG. 13 is displayed on the display 12, the user adjusts a positional relationship between the reading device 10 and the wireless communication medium 30 as illustrated in FIG. 15. FIG. 15 is a diagram illustrating a scene in which a positional relationship between the reading device 10 and the wireless communication medium 30 is adjusted according to the display element G3 based on the guide information illustrated in FIG. 13. As illustrated, wireless communication is executed between the reading device 10 and the wireless communication medium 30 by placing the wireless communication medium 30 at a communication position of the reading device 10 according to the display element G3 based on the guide information (S216).

Note that, considering that a positional relationship between the reading device 10 and the wireless communication medium 30 during wireless communication is in such a state as described in FIG. 2, such a display element as illustrated in FIG. 13 is preferable. For example, as illustrated in FIG. 15, owing to a user interface that is easy to understand as if the wireless communication medium 30 was seen through, it can be said that an appropriate positional relationship between the reading device 10 and the wireless communication medium 30 becomes easy for the user to visually recognize.

In the present example embodiment, based on guide information determined according to a combination of a model of the reading device 10 that performs communication with the wireless communication medium 30 and a type of the wireless communication medium 30, a display element indicating an appropriate positional relationship between the reading device 10 and the wireless communication medium 30 is displayed on the display 12. Owing to a display element based on the guide information, the user can easily adjust a positional relationship between the reading device 10 and the wireless communication medium 30 in such a way that stable wireless communication can be executed between the reading device 10 and the wireless communication medium 30. Moreover, since using medium type information allows an internal structure (a position of an antenna or the like) of the wireless communication medium 30 to be further considered, a position where communication can be stably performed between the reading device 10 and the wireless communication medium 30 can be determined more accurately, as compared with the first example embodiment.

### Modified Example

In the present example embodiment as well, the display processing unit 130 may be configured in such a way as to cause the display 12 to further display information indicating a remaining time until communication completion, for example, while the medium 30 is placed at a communication position of the reading device 10. The present modified example is different from the modified example of the first example embodiment in the following description.

As described in the modified example of the first example embodiment, a time required until communication with the wireless communication medium 30 is completed is variable according to model-specific information such as a specification of the reading device 10. Moreover, a time required for wireless communication is also variable depending on a structure of the wireless communication medium 30, and information to be read or information to be written. In the present example embodiment, unlike the first example embodiment, since medium type information indicating a type of the wireless communication medium 30 is further acquired, it becomes possible to determine a time required for wireless communication in consideration of a “type of the wireless communication medium 30”.

For example, the display processing unit 130 according to the modified example can more accurately acquire a time required until communication with the wireless communication medium 30 is completed, based on a combination of model information and medium type information. Note that, a communication time according to a combination of a model of the reading device 10 and a type of the wireless communication medium 30 can be determined based on, for example, a result of actually executing reading and writing for each combination of the model of the reading device 10 and the type of the wireless communication medium 30. Moreover, a theoretical value based on a specification of the reading device 10 and an average data communication charge of the wireless communication medium 30 may be used for a communication time according to a combination of a model of the reading device 10 and a type of the wireless communication medium 30. The communication time according to a combination of a model of the reading device 10 and a type of the wireless communication medium 30 acquired in this way is converted into a database in association with, for example, the model information of the reading device 10.

In this case, the display processing unit 130 can acquire an associated communication time from the database. Then, the display processing unit 130 can display information indicating a remaining time until a wireless communication is completed, for example, as illustrated in FIG. 10, based on a communication time acquired according to a combination, and an elapsed time of a timer activated in response to start of wireless communication with the wireless communication medium 30.

### Third Example Embodiment

The present example embodiment is similar to the second example embodiment except for a point described below. For example, a reading system 1 according to the present example embodiment has a functional configuration (example: FIG. 1) similar to that of the reading system 1 according to the second example embodiment, except for the points described below.

### <Configuration of Server Apparatus 20>

An acquisition unit 210 according to the present example embodiment acquires model information and medium type information from the reading device 10, similarly to the second example embodiment. A guide information transmission unit 220 acquires, based on a combination of model information and medium type information acquired by the acquisition unit 210, associated guide information from a guide information database 40. Then, the guide information transmission unit 220 transmits, to the reading device 10, guide information based on the combination of the model information and the medium type information. Herein, the guide information according to the present example embodiment includes information indicating changes over time in a display magnification and a display position of an image indicating an appearance of a wireless communication medium.

### <Configuration of Reading Device 10>

In the present example embodiment, a reception unit 120 acquires, as response information to a combination of model information and medium type information transmitted to a server apparatus 20, guide information including information indicating changes over time in a display magnification and a display position of an image indicating an appearance of a wireless communication medium. A display processing unit 130 according to the present example embodiment becomes capable of displaying a display element being easy for a user to understand, based on such guide information, regarding an operation of placing a wireless communication medium at a communication position of the reading device 10.

### Display Example by Display Processing Unit 130

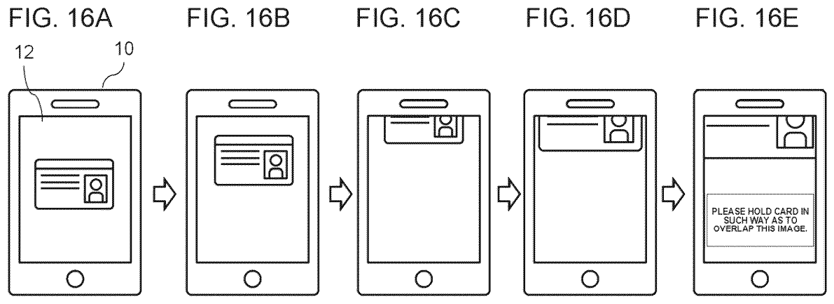

FIG. 16 is a diagram illustrating one example of a display element based on guide information output by the display processing unit 130 according to the third example embodiment.

First, the display processing unit 130 according to the present example embodiment acquires an image indicating an entire appearance of a wireless communication medium (hereinafter also referred to as a “medium appearance image”) determined based on medium type information of a wireless communication medium (example: FIG. 16(a)). The medium appearance image indicating the entire appearance of the wireless communication medium may be included in the guide information transmitted from the server apparatus 20, or may be previously stored in association with associated medium type information in a storage device 1040 of the reading device 10 or the like.

As illustrated in FIG. 16, the display processing unit 130 displays a medium appearance image on a display 12 of the reading device 10 at such a display magnification and a display position that an entire appearance of a wireless communication medium used for wireless communication can be visually recognized. Note that, an initial display magnification and an initial display position (positional coordinate) of a medium appearance image are defined, for example, within guide information acquired as response information to a combination of model information and medium type information. By displaying a medium appearance image in such a way as that the medium appearance image can be visually recognized entirely, a user can easily recognize a type of a wireless communication medium used for wireless communication.

Then, the display processing unit 130 changes a display state of the medium appearance image on the display 12 according to information included in guide information and indicating a change over time in a display magnification and a display position of a medium appearance image. For example, as illustrated in FIGS. 16(b) to (e), the display processing unit 130 expresses, by an animation, a scene in which the wireless communication medium is moved to a reading position of the reading device 10, based on information indicating changes over time in a display magnification and a display position.

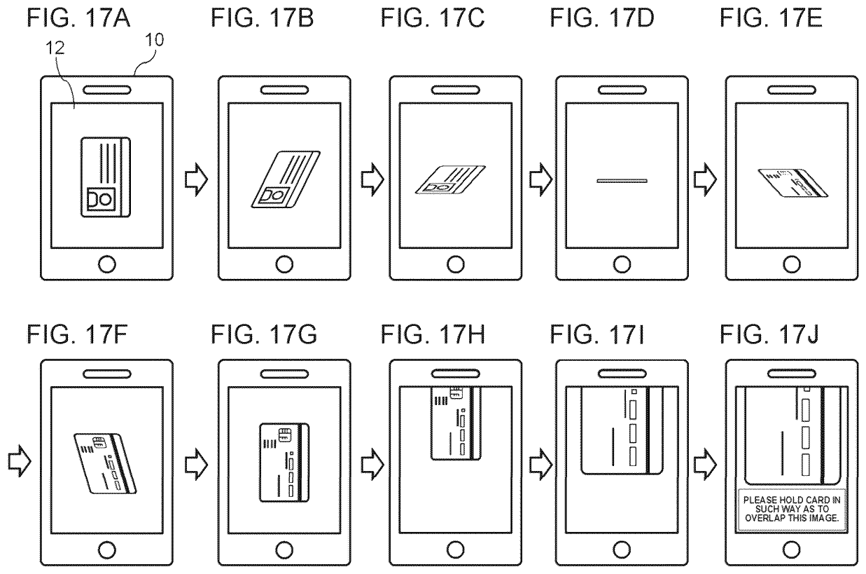

Note that, when a medium appearance image has information of a three-dimensional appearance model, the display processing unit 130 can express, by an animation, a scene in which the medium appearance image is rotated, or the like (example: FIG. 17(a) to (i)). FIG. 17 is a diagram illustrating another example of a display element based on guide information output by the display processing unit 130 according to the third example embodiment. By expressing the three-dimensional movement by an animation as illustrated in FIG. 17, the user can easily recognize how to hold a wireless communication medium over the reading device 10 when the reading device 10 reads the wireless communication medium.

While the example embodiments according to the present invention have been described above with reference to the drawings, the present invention should not be interpreted by being limited to the example embodiments, and various modifications, improvements, and the like can be made based on knowledge of a person skilled in the art without departing from the spirit of the present invention. Moreover, a plurality of components disclosed in the example embodiments can be appropriately combined and thereby form various inventions. For example, some components may be deleted from all components illustrated in the example embodiments, or components according to different example embodiments may be combined as appropriate.

For example, in the example embodiment described above, an example in which a database (guide information database 40) that stores guide information for each piece of model information or for each combination of model information and medium type information is provided on the server apparatus 20 side has been mainly described, but such a database may be built in the reading device 10. For example, when installing an application that operates on the reading device 10, a database that stores guide information for each model information or for each combination of model information and medium type information may be built in the storage area of the reading device 10. In this case, the reading device 10 can independently execute processing up to displaying of guide information.

Moreover, although a plurality of steps (pieces of processing) are described in order in a plurality of flowcharts used in the above description, an execution order of steps executed in each example embodiment is not limited to the described order. In each example embodiment, an order of illustrated steps can be changed to an extent that causes no problem in terms of content. Moreover, each of the example embodiments described above can be combined to an extent that content does not contradict.

Some or all of the above-described example embodiments can also be described as, but are not limited to, the following supplementary notes.
1. A server apparatus including:
   an acquisition unit that acquires model information of a reading device having a display; and
   a guide information transmission unit that acquires, based on the model information, guide information for causing the display to display a position of a wireless communication medium relative to the reading device during wireless communication, and transmits the guide information to the reading device.
2. The server apparatus according to supplementary note 1, in which
   the guide information includes information indicating a position of at least a part of an edge of the wireless communication medium when the wireless communication medium is placed at a communication position of the reading device.
3. The server apparatus according to supplementary note 1 or 2, in which
   the acquisition unit further acquires medium type information indicating a type of the wireless communication medium, and
   the guide information transmission unit determines the guide information, based on a combination of the model information and the medium type information.
4. The server apparatus according to supplementary note 3, in which
   the guide information includes information indicating an appearance of a region of the wireless communication medium overlapping the display when the wireless communication medium is placed at a communication position of the reading device.
5. The server apparatus according to supplementary note 3, in which
   the guide information includes information indicating a position of criterion information being included in a region of the wireless communication medium overlapping the display when the wireless communication medium is placed at a communication position of the reading device.
6. The server apparatus according to supplementary note 3, in which
   the guide information includes information indicating a change over time in a display magnification and a display position relating to an image indicating an appearance of the wireless communication medium.
7. A reading operation assistance method including,
   by a computer:
   acquiring model information of a reading device having a display;
   acquiring, based on the model information, guide information for causing the display to display a position of a wireless communication medium relative to the reading device during wireless communication; and
   transmitting the guide information to the reading device.
8. The reading operation assistance method according to supplementary note 7, in which
   the guide information includes information indicating a position of at least a part of an edge of the wireless communication medium when the wireless communication medium is placed at a communication position of the reading device.
9. The reading operation assistance method according to supplementary note 7 or 8, further including,
   by the computer:
   further acquiring medium type information indicating a type of the wireless communication medium; and
   determining the guide information, based on a combination of the model information and the medium type information.
10. The reading operation assistance method according to supplementary note 9, in which
   the guide information includes information indicating an appearance of a region of the wireless communication medium overlapping the display when the wireless communication medium is placed at a communication position of the reading device.
11. The reading operation assistance method according to supplementary note 9, in which
   the guide information includes information indicating a position of criterion information being included in a region of the wireless communication medium overlapping the display when the wireless communication medium is placed at a communication position of the reading device.
12. The reading operation assistance method according to supplementary note 9, in which
   the guide information includes information indicating a change over time in a display magnification and a display position relating to an image indicating an appearance of the wireless communication medium.
13. A program causing
   a computer to function as:
   an acquisition unit that acquires model information of a reading device having a display; and
   a guide information transmission unit that acquires, based on the model information, guide information for causing the display to display a position of a wireless communication medium relative to the reading device during wireless communication, and transmits the guide information to the reading device.
14. The program according to supplementary note 13, in which
   the guide information includes information indicating a position of at least a part of an edge of the wireless communication medium when the wireless communication medium is placed at a communication position of the reading device.
15. The program according to supplementary note 13 or 14, in which the acquisition unit further acquires medium type information indicating a type of the wireless communication medium, and
   the guide information transmission unit determines the guide information, based on a combination of the model information and the medium type information.
16. The program according to supplementary note 15, in which
   the guide information includes information indicating an appearance of a region of the wireless communication medium overlapping the display when the wireless communication medium is placed at a communication position of the reading device.
17. The program according to supplementary note 15, in which
   the guide information includes information indicating a position of criterion information being included in a region of the wireless communication medium overlapping the display when the wireless communication medium is placed at a communication position of the reading device.
18. The program according to supplementary note 15, in which
   the guide information includes information indicating a change over time in a display magnification and a display position relating to an image indicating an appearance of the wireless communication medium.
19. A program to be installed in a reading device having a display, causing
   the reading device to function as:
      a transmission unit that transmits model information of the reading device to a server apparatus;
      a reception unit that receives guide information for causing the display to display a position of a wireless communication medium relative to the reading device during wireless communication, the guide information being determined based on the model information by the server apparatus; and
      a display processing unit that causes the display of the reading device to display, based on the guide information, a display element indicating a position of the wireless communication medium relative to the reading device during wireless communication.
20. The program according to supplementary note 19, in which
   the guide information includes information indicating a position of at least a part of an edge of the wireless communication medium when the wireless communication medium is placed at a communication position of the reading device.
21. The program according to supplementary note 19 or 20, in which
   the display processing unit causes the display to further display information indicating a remaining time until reading completion according to the model information while the wireless communication medium is placed at a communication position of the reading device.
22. The program according to any one of supplementary notes 19 to 21, in which
   the transmission unit further acquires medium type information indicating a type of the wireless communication medium, and transmits the model information and the medium type information to the server apparatus, and
   the reception unit receives the guide information being determined by the server apparatus, based on a combination of the model information and the medium type information.
23. The program according to supplementary note 22, in which
   the guide information includes information indicating an appearance of a region of the wireless communication medium overlapping the display when the wireless communication medium is placed at a communication position of the reading device.
24. The program according to supplementary note 22, in which
the guide information includes information indicating a position of criterion information being included in a region of the wireless communication medium overlapping the display when the wireless communication medium is placed at a communication position of the reading device.
25. The program according to supplementary note 22, in which
   the guide information includes information indicating a change over time in a display magnification and a display position relating to an image indicating an appearance of the wireless communication medium.
26. The program according to supplementary note 25, in which
   the display processing unit displays, on the display, an entire image indicating an appearance of the wireless communication medium, and then changes, based on the guide information, a display state of the image indicating the appearance of the wireless communication medium.
27. The program according to supplementary note 26, in which
   The display processing unit expresses, by an animation, a change in a display state of the image indicating the appearance of the wireless communication medium, based on information indicating a change over time in a display magnification and a display position of the guide information.
28. The program according to any one of supplementary notes 22 to 27, in which
   the display processing unit causes the display to further display information indicating a remaining time until reading completion according to a combination of the model information and the medium type information, while the wireless communication medium is placed at a communication position of the reading device.
29. A reading operation assistance method including, by a reading device having a display:
   transmitting model information of the reading device to a server apparatus;
   receiving guide information for causing the display to display a position of a wireless communication medium relative to the reading device during wireless communication, the guide information being determined based on the model information by the server apparatus; and
   causing the display of the reading device to display, based on the guide information, a display element indicating a position of the wireless communication medium relative to the reading device during wireless communication.
30. The reading operation assistance method according to supplementary note 29, in which
   the guide information includes information indicating a position of at least a part of an edge of the wireless communication medium when the wireless communication medium is placed at a communication position of the reading device.
31. The reading operation assistance method according to supplementary note 29 or 30, further including,
   by the reading device,
   causing the display to further display information indicating a remaining time until reading completion according to the model information while the wireless communication medium is placed at a communication position of the reading device.
32. The reading operation assistance method according to any one of supplementary notes 29 to 31, further including,
   by the reading device:
   further acquiring medium type information indicating a type of the wireless communication medium, and transmitting the model information and the medium type information to the server apparatus; and
   receiving the guide information determined by the server apparatus, based on a combination of the model information and the medium type information.
33. The reading operation assistance method according to supplementary note 32, in which
   the guide information includes information indicating an appearance of a region of the wireless communication medium overlapping the display when the wireless communication medium is placed at a communication position of the reading device.
34. The reading operation assistance method according to supplementary note 32, in which
   the guide information includes information indicating a position of criterion information being included in a region of the wireless communication medium overlapping the display when the wireless communication medium is placed at a communication position of the reading device.
35. The reading operation assistance method according to supplementary note 32, in which
   the guide information includes information indicating a change over time in a display magnification and a display position relating to an image indicating an appearance of the wireless communication medium.
36. The reading operation assistance method according to supplementary note 35, further including,
   by the reading device, displaying, on the display, an entire image indicating an appearance of the wireless communication medium, and then changing, based on the guide information, a display state of the image indicating the appearance of the wireless communication medium.
37. The reading operation assistance method according to supplementary note 36, further including,
   by the reading device, expressing, by an animation, a change in a display state of the image indicating the appearance of the wireless communication medium, based on information indicating a change over time in a display magnification and a display position of the guide information.
38. The reading operation assistance method according to any one of supplementary notes 32 to 37, further including,
   by the reading device,
   causing the display to further display information indicating a remaining time until reading completion according to a combination of the model information and the medium type information, while the wireless communication medium is placed at a communication position of the reading device.
39. A reading device having a display, the reading device including:
   a transmission unit that transmits model information of the reading device to a server apparatus;
   a reception unit that receives guide information for causing the display to display a position of a wireless communication medium relative to the reading device during wireless communication, the guide information being determined based on the model information by the server apparatus; and
   a display processing unit that causes the display of the reading device to display, based on the guide information, a display element indicating a position of the wireless communication medium relative to the reading device during wireless communication.
40. The reading device according to supplementary note 39, in which
   a communication unit that performs wireless communication with the wireless communication medium is provided on a second surface side located on a side opposite to a first surface on which the display is provided.
41. The reading device according to supplementary note 39 or 40, in which
   the reading device is a portable terminal.
42. The reading device according to any one of supplementary notes 39 to 41, in which
   the guide information includes information indicating a position of at least a part of an edge of the wireless communication medium when the wireless communication medium is placed at a communication position of the reading device.
43. The reading device according to any one of supplementary notes 39 to 42, in which
   the display processing unit causes the display to further display information indicating a remaining time until reading completion according to the model information while the wireless communication medium is placed at a communication position of the reading device.
44. The reading device according to any one of supplementary notes 39 to 43, in which
   the transmission unit further acquires medium type information indicating a type of the wireless communication medium, and transmits the model information and the medium type information to the server apparatus, and
   the reception unit receives the guide information determined by the server apparatus, based on a combination of the model information and the medium type information.
45. The reading device according to supplementary note 44, in which
   the guide information includes information indicating an appearance of a region of the wireless communication medium overlapping the display when the wireless communication medium is placed at a communication position of the reading device.
46. The reading device according to supplementary note 44, in which
   the guide information includes information indicating a position of criterion information being included in a region of the wireless communication medium overlapping the display when the wireless communication medium is placed at a communication position of the reading device.
47. The reading device according to supplementary note 44, in which
   the guide information includes information indicating a change over time in a display magnification and a display position relating to an image indicating an appearance of the wireless communication medium.
48. The reading device according to supplementary note 47, in which
   the display processing unit displays, on the display, an entire image indicating an appearance of the wireless communication medium, and then changes, based on the guide information, a display state of the image indicating the appearance of the wireless communication medium.
49. The reading device according to supplementary note 48, in which
   the display processing unit expresses, by an animation, a change in a display state of the image indicating the appearance of the wireless communication medium, based on information indicating a change over time in a display magnification and a display position of the guide information.
50. The reading device according to any one of supplementary notes 44 to 49, in which
   the display processing unit causes the display to further display information indicating a remaining time until reading completion according to a combination of the model information and the medium type information, while the wireless communication medium is placed at a communication position of the reading device.

This application is based upon and claims the benefit of priority from Japanese patent application No. 2021-096518 filed on Jun. 9, 2021 and Japanese patent application No. 2021-192841 filed on Nov. 29, 2021, the disclosures of which are incorporated herein in its entirety by reference.

### REFERENCE SIGNS LIST

1 Reading system
10 Reading device
12 Display
110 Transmission unit
112 Wireless communication module
120 Reception unit
130 Display processing unit
140 Communication unit
1010 Bus
1020 Processor
1030 Memory
1040 Storage device
1050 Input/output interface
1060 Network interface
1062 Wireless communication module
20 Server apparatus
210 Acquisition unit
220 Guide information transmission unit
2010 Bus
2020 Processor
2030 Memory
2040 Storage device
2050 Input/output interface
2060 Network interface
30 Wireless communication medium
40 Guide information database

What is claimed is:

1. A server apparatus comprising:
at least one memory configured to store instructions; and
at least one processor configured to execute the instructions to perform operations, the operations comprising:
acquiring model information of a reading device having a display;
acquiring, based on the model information, guide information for causing the display to display a position of a wireless communication medium relative to the reading device during wireless communication; and
transmitting the guide information to the reading device.

2. The server apparatus according to claim 1, wherein
the guide information includes information indicating a position of at least a part of an edge of the wireless communication medium when the wireless communication medium is placed at a communication position of the reading device.

3. The server apparatus according to claim 1, wherein the operations further comprise
acquiring medium type information indicating a type of the wireless communication medium, and
determining the guide information, based on a combination of the model information and the medium type information.

4. The server apparatus according to claim 3, wherein
the guide information includes information indicating an appearance of a region of the wireless communication medium overlapping the display when the wireless communication medium is placed at a communication position of the reading device.

5. The server apparatus according to claim 3, wherein
the guide information includes information indicating a position of criterion information being included in a region of the wireless communication medium overlapping the display when the wireless communication medium is placed at a communication position of the reading device.

6. The server apparatus according to claim 3, wherein
the guide information includes information indicating a change over time in a display magnification and a display position relating to an image indicating an appearance of the wireless communication medium.

7. A reading operation assistance method comprising,
by a computer:
acquiring model information of a reading device having a display;
acquiring, based on the model information, guide information for causing the display to display a position of a wireless communication medium relative to the reading device during wireless communication; and
transmitting the guide information to the reading device.

8. The reading operation assistance method according to claim 7, wherein
the guide information includes information indicating a position of at least a part of an edge of the wireless communication medium when the wireless communication medium is placed at a communication position of the reading device.

9. The reading operation assistance method according to claim 7, further comprising,
by the computer:
further acquiring medium type information indicating a type of the wireless communication medium; and
determining the guide information, based on a combination of the model information and the medium type information.

10. The reading operation assistance method according to claim 9, wherein
the guide information includes information indicating an appearance of a region of the wireless communication medium overlapping the display when the wireless communication medium is placed at a communication position of the reading device.

11-18. (canceled)

19. A non-transitory computer-readable medium storing a program for causing a reading device having a display to perform operations, the operations comprising:
transmitting model information of the reading device to a server apparatus;
receiving guide information for causing the display to display a position of a wireless communication medium relative to the reading device during wireless communication, the guide information being determined based on the model information by the server apparatus; and
causing the display of the reading device to display, based on the guide information, a display element indicating a position of the wireless communication medium relative to the reading device during wireless communication.

20. The non-transitory computer-readable medium according to claim 19, wherein
the guide information includes information indicating a position of at least a part of an edge of the wireless communication medium when the wireless communication medium is placed at a communication position of the reading device.

21. The non-transitory computer-readable medium according to claim 19, wherein
the operations further comprise causing the display to further display information indicating a remaining time until reading completion according to the model information while the wireless communication medium is placed at a communication position of the reading device.

22. The non-transitory computer-readable medium according to claim 19, wherein the operations further comprise
acquiring medium type information indicating a type of the wireless communication medium,
transmitting the model information and the medium type information to the server apparatus, and
receiving the guide information being determined by the server apparatus, based on a combination of the model information and the medium type information.

23. The non-transitory computer-readable medium according to claim 22, wherein
the guide information includes information indicating an appearance of a region of the wireless communication medium overlapping the display when the wireless communication medium is placed at a communication position of the reading device.

24. The non-transitory computer-readable medium according to claim 22, wherein
the guide information includes information indicating a position of criterion information being included in a region of the wireless communication medium overlapping the display when the wireless communication medium is placed at a communication position of the reading device.

25. The non-transitory computer-readable medium according to claim 22, wherein
the guide information includes information indicating a change over time in a display magnification and a display position relating to an image indicating an appearance of the wireless communication medium.

26. The non-transitory computer-readable medium according to claim 25, wherein
the operations further comprise displaying, on the display, an entire image indicating an appearance of the wireless communication medium, and then changinq, based on the guide information, a display state of the image indicating the appearance of the wireless communication medium.

27. The non-transitory computer-readable medium according to claim 26, wherein
the operations further comprise expressing, by an animation, a change in a display state of the image indicating the appearance of the wireless communication medium, based on information indicating a change over time in a display magnification and a display position of the guide information.

28. The non-transitory computer-readable medium according to claim 22, wherein
the operations further comprise causing the display to further display information indicating a remaining time until reading completion according to a combination of the model information and the medium type information, while the wireless communication medium is placed at a communication position of the reading device.

29-50. (canceled)
